(19) United States
(12) Patent Application Publication
(10) Pub. No.: US 2006/0287858 A1
(43) Pub. Date: Dec. 21, 2006

(54) Modifying a grammar of a hierarchical multimodal menu with keywords sold to customers

(76) Inventors: Charles W. Cross JR., Wellington, FL (US); Michael C. Hollinger, Memphis, TN (US); Igor R. Jablokov, Charlotte, NC (US); Benjamin D. Lewis, Ann Arbor, MI (US); Hilary A. Pike, Austin, TX (US); Daniel M. Smith, Raleigh, NC (US); David W. Wintermute, Boynton Beach, FL (US); Michael A. Zaitzeff, Carson City, NV (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/154,895

(22) Filed: Jun. 16, 2005

(51) Int. Cl. G10L 15/00

(52) U.S. Cl. 704/257

(57) ABSTRACT

Services, systems, and computer program products are provided for modifying a grammar of a hierarchical multimodal menu that include selling to a customer a keyword, selling to a customer a location in a grammar in a hierarchical multimodal menu, and storing the keyword in the location. Storing the keyword in the location may be carried out by storing the keyword in a grammar cache in the grammar.

### BACKGROUND OF THE INVENTION

1. Field of the Invention

The field of the invention is data processing, or, more specifically, methods, systems, and products for modifying a grammar of a hierarchical multimodal menu.

2. Description of Related Art

User interaction with applications running on small devices through a keyboard or stylus has become increasingly limited and cumbersome as those devices have become increasingly smaller. In particular, small handheld devices like mobile phones and PDAs serve many functions and contain sufficient processing power to support user interaction through other modes, such as multimodal access. Devices which support multimodal access combine multiple user input modes or channels in the same interaction allowing a user to interact with the applications on the device simultaneously through multiple input modes or channels. The methods of input include speech recognition, keyboard, touch screen, stylus, mouse, handwriting, and others. Multimodal input often makes using a small device easier.

A multimodal application is an application capable of receiving multimodal input and interacting with users through multimodal output. Such multimodal applications typically support multimodal interaction through hierarchical menus that may be speech driven. Such speech driven menus have a grammar that is subdivided to provide a limited grammar at each tier of the hierarchical menu. Such subdivided limited grammars are assigned to a particular tier in the hierarchical menu that corresponds to the menu choices presented to a user at that tier. A user may navigate each tier of the menu by invoking speech commands in the limited subdivided grammars of that tier that correspond to the menu choices before the user. Only the limited grammars corresponding to the user's current menu choices are typically enabled and therefore available as speech commands for the user. These limited subdivided grammars can typically support more keywords and therefore are often underutilized. Keywords in such grammars are also not available for sale to customers who may otherwise pay a premium for quality words and locations in such underutilized grammars. There is therefore an ongoing need for modifying grammars of hierarchical multimodal menus with keywords sold to customers.

### SUMMARY OF THE INVENTION

Methods, systems, and computer program products are provided for modifying a grammar of a hierarchical multimodal menu that include selling to a customer a keyword, selling to a customer a location in a grammar in a hierarchical multimodal menu, and storing the keyword in the location. Storing the keyword in the location may be carried out by storing the keyword in a grammar cache in the grammar.

Selling to a customer a location in a grammar in a hierarchical multimodal menu may be carried out by identifying a tier in the hierarchical multimodal menu and assigning a sale price to a location in a grammar associated with the tier in the hierarchical multimodal menu. Selling to a customer a location in a grammar in a hierarchical multimodal menu may also be carried out by receiving a bid price from the customer, selecting a tier in the hierarchical multimodal menu in dependence upon the bid price. Storing the keyword in the location often includes storing the keyword in a location in a grammar associated with the selected tier.

Modifying a grammar of a hierarchical multimodal menu according to embodiments of the present invention may also include adding a GUI display object associated with the customer keyword to the hierarchical multimodal menu and associating the keyword with an action.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system of devices each of which is capable of supporting a multimodal application such as a multimodal browser that implements a grammar modified according to embodiments of the present invention.

FIG. 2 sets forth a block diagram of a multimodal framework useful in implementing embodiments of the present invention.

FIG. 3 sets forth a block diagram of automated computing machinery comprising an exemplary computer capable of supporting a multimodal application having a grammar modified in accordance with the present invention.

FIG. 4 sets forth a flow chart illustrating an exemplary method for modifying a grammar of a hierarchical multimodal menu.

FIG. 5 sets forth a flow chart illustrating an exemplary method for selling to a customer a location in a grammar in a hierarchical multimodal menu.

FIG. 6 sets forth another exemplary method for selling to a customer a location in a grammar in a hierarchical multimodal menu.

FIG. 7 sets forth a line drawing of an exemplary hierarchical multimodal menu displayed within a multimodal browser.

FIG. 8 sets forth the menu of FIG. 7 with a visual representation of exemplary keywords stored in grammar caches.

FIG. 9 sets forth a line drawing of an exemplary data processing system useful in modifying a grammar of a hierarchical multimodal menu.

### DETAILED DESCRIPTION OF EXEMPLARY EMBODIMENTS

### Introduction

The present invention is described to a large extent in this specification in terms of methods for modifying a grammar of a hierarchical multimodal menu. Persons skilled in the art, however, will recognize that any computer system that includes suitable programming means for operating in accordance with the disclosed methods also falls well within the scope of the present invention. Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit.

The invention also may be embodied in a computer program product, such as a diskette or other recording medium, for use with any suitable data processing system. Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Modifying a Grammar of a Hierarchical Multimodal Menu with Keywords Sold to Customers

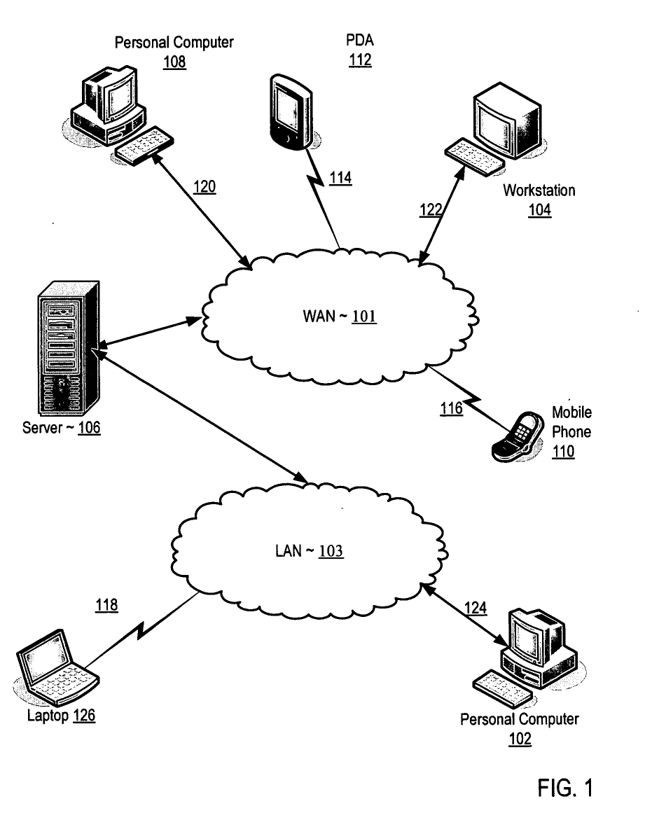

Exemplary methods, systems, and products for modifying a grammar of a hierarchical multimodal menu according to embodiments of the present invention are described with reference to the accompanying drawings, beginning with FIG. 1. FIG. 1 sets forth a network diagram illustrating an exemplary system of devices each of which is capable of supporting a multimodal application such as a multimodal browser that implements a grammar modified according to embodiments of the present invention. The system of FIG. 1 includes a number of computers connected for data communications in networks. Each of the computers of the system of FIG. 1 may have a multimodal application installed upon it.

The data processing system of FIG. 1 includes wide area network (“WAN”) (101) and local area network (“LAN”) (103). The network connection aspect of the architecture of FIG. 1 is only for explanation, not for limitation. In fact, systems having multimodal applications that implement hierarchical menus having grammars modified according to embodiments of the present invention may be connected as LANs, WANs, intranets, internets, the Internet, webs, the World Wide Web itself, or other connections as will occur to those of skill in the art. Such networks are media that may be used to provide data communications connections between various devices and computers connected together within an overall data processing system.

In the example of FIG. 1, server (106) implements a gateway, router, or bridge between LAN (103) and WAN (101). Server (106) may be any computer capable of accepting a request for a resource and responding by providing the resource to the requester. One example of such a server is an HTTP (‘HyperText Transport Protocol’) server or ‘web server.’ The exemplary server (106) is capable of serving up multimodal web pages that are capable of being displayed through a multimodal application such as a multimodal browser.

The exemplary server (106) of FIG. 1 is also capable of supporting a multimodal web application implementing a grammar modified according to embodiments of the present invention. Such a multimodal web application may include an advertising keyword grammar module that includes a keyword location in a hierarchical multimodal menu sold to a customer and a keyword sold to a customer stored in the keyword location.

The exemplary client devices (108, 112, 104, 110, 126, and 102) support multimodal applications such as a multimodal browser capable of data communications with a multimodal web application on the server (106) having a grammar modified in accordance with the present invention. A ‘multimodal browser,’ as the term is used in this specification, generally means a web browser capable of receiving multimodal input and interacting with users with multimodal output. Multimodal browsers typically render web pages written in XHTML+Voice (X+V). X+V provides a markup language that enables users to interact with application through spoken dialog in addition to traditional means of input such as keyboard strokes and mouse pointer action. X+V adds spoken interaction to standard web content by integrating XHTML (eXtensible Hypertext Markup Language) and speech recognition vocabularies. XHTML includes voice modules that support speech synthesis, speech dialogs, command and control, and speech grammars. Voice handlers can be attached to XHTML elements and respond to specific events. Voice interaction features are integrated with XHTML and can consequently be used directly within XHTML content.

In the example of FIG. 1, several exemplary devices including a PDA (112), a computer workstation (104), a mobile phone (110), and a personal computer (108) are connected to WAN (101). Network-enabled mobile phone (110) connects to the WAN (101) through a wireless link (116), and the PDA (112) connects to the network (101) through a wireless link (114). In the example of FIG. 1, the personal computer (108) connects through a wireline connection (120) to the WAN (101) and the computer workstation (104) connects through a wireline connection (122) to the WAN (101). In the example of FIG. 1, the laptop (126) connects through a wireless link (118) to the LAN (103) and the personal computer (102) connects through a wireline connection (124) to LAN (103).

In the system of FIG. 1, exemplary client devices (108, 112, 104, 110, 126, and 102) support multimodal applications, such multimodal browsers, capable of data communications with a multimodal web application on the server (106) having a grammar modified in accordance with the present invention. Such grammars are useful in allowing a user to interact through speech with the application through a hierarchical menu. Such grammars are modified by selling to a customer a keyword, selling to a customer a location in a grammar in a hierarchical multimodal menu, and storing the keyword in the location. Selling customers keywords and locations in a hierarchical multimodal menu provides to those customers the ability to increase their presence with users of the menu. That is, a customer's keyword in such a grammar provides a hook to interacting with the user when the user speaks the keyword while navigating the menu.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP/IP, HTTP, WAP, HDTP, and others as will occur to those of skill in the art. Various embodiments of the present invention may be implemented on a variety of hardware platforms in addition to those illustrated in FIG. 1.

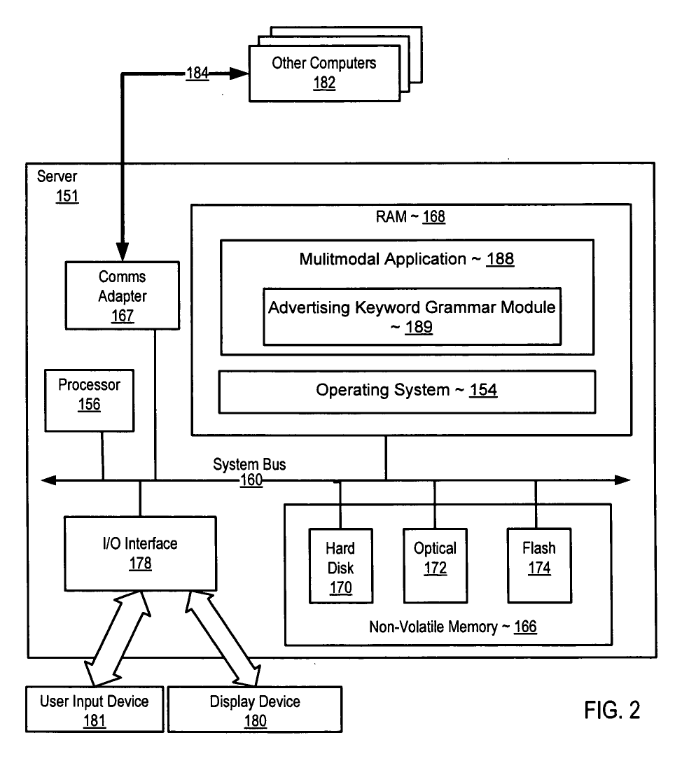

Multimodal applications that support hierarchical menus having grammars modified in accordance with the present invention are generally implemented with computers, that is, with automated computing machinery. For further explanation, therefore, FIG. 2 sets forth a block diagram of automated computing machinery comprising an exemplary server (151) capable of supporting a multimodal application (188) having an advertising keyword grammar module (189) supporting a grammar modified in accordance with the present invention.

The server (151) of FIG. 2 includes at least one computer processor (156) or ‘CPU’ as well as random access memory (168) (“RAM”) which is connected through a system bus (160) to processor (156) and to other components of the computer. Stored in RAM (168) is an operating system (154). Operating systems useful in computers according to embodiments of the present invention include UNIX™, Linux™, Microsoft NT™, AIX™, IBM's i5os, and many others as will occur to those of skill in the art.

Also stored in RAM (168) is a multimodal application (188) having a hierarchical menu that implements a grammar through an advertising keyword grammar module (189) that supports grammars modified according to embodiments of the present invention. The advertising keyword grammar module (189) supports grammars modified by selling to a customer a keyword, selling to a customer a location in a grammar in a hierarchical multimodal menu, and storing the keyword in the location. Selling customers keywords and locations in a hierarchical multimodal menu provides to those customers the ability to increase their presence with users accessing those menus through multimodal browsers running on client devices. That is, a customer's keyword in such a grammar provides a hook to interacting with the user when the user speaks the keyword while navigating the menu with a multimodal browser on a client device.

Server (151) of FIG. 2 includes non-volatile computer memory (166) coupled through a system bus (160) to processor (156) and to other components of the server (151). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The exemplary server (151) of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary server (151) of FIG. 2 includes a communications adapter (167) for implementing data communications (184) with other computers (182). Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful in multimodal applications according to embodiments of the present invention include modems for wired dial-up communications, Ethernet (IEEE 802.3) adapters for wired network communications, and 802.11b adapters for wireless network communications.

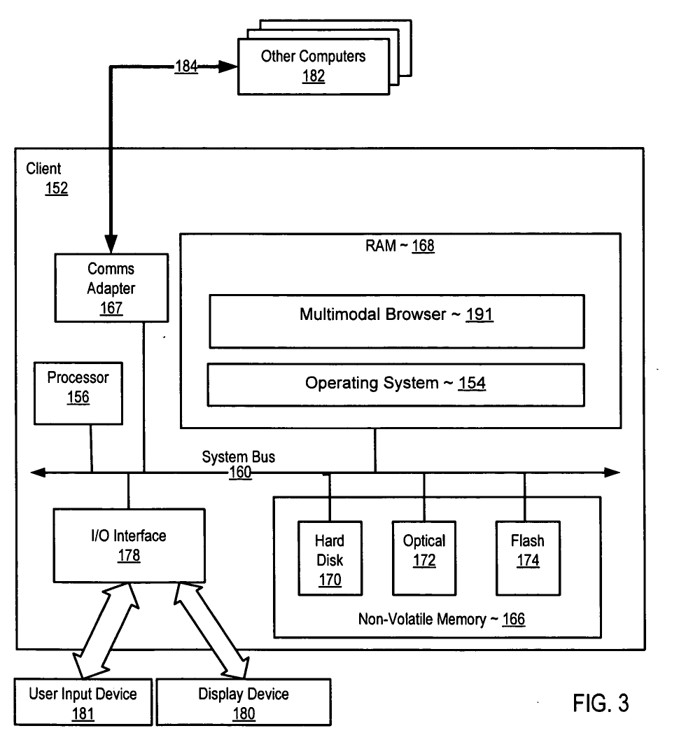

Hierarchical menus having grammars modified in accordance with the present invention are generally navigated by users with multimodal browsers implemented with client devices, that is, with automated computing machinery. For further explanation, therefore, FIG. 3 sets forth a block diagram of automated computing machinery comprising an exemplary client (152) capable of supporting a multimodal browser capable of navigating a menu having a grammar modified in accordance with the present invention.

The client (152) of FIG. 3 includes at least one computer processor (156) or ‘CPU’ as well as random access memory (168) (“RAM”) which is connected through a system bus (160) to processor (156) and to other components of the computer. Stored in RAM (168) is an operating system (154). Operating systems useful in computers according to embodiments of the present invention include UNIX™, Linux™, Microsoft NT™, AIX™, IBM's i5os, and many others as will occur to those of skill in the art.

Also stored in RAM (168) is a multimodal browser (191) empowering a user to navigate a hierarchical multimodal menu that implements a grammar modified according to embodiments of the present invention. Such a grammar is modified by selling to a customer a keyword, selling to a customer a location in a grammar in a hierarchical multimodal menu, and storing the keyword in the location. Selling customers keywords and locations in a hierarchical multimodal menu provides to those customers the ability to increase their presence with users of the menu. That is, a customer's keyword in such a grammar provides a hook to interacting with the user when the user speaks the keyword while navigating the menu.

Client (152) of FIG. 3 includes non-volatile computer memory (166) coupled through a system bus (160) to processor (156) and to other components of the client (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The exemplary client of FIG. 3 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary client (152) of FIG. 3 includes a communications adapter (167) for implementing data communications (184) with other computers (182). Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful in multimodal applications according to embodiments of the present invention include modems for wired dial-up communications, Ethernet (IEEE 802.3) adapters for wired network communications, and 802.11b adapters for wireless network communications.

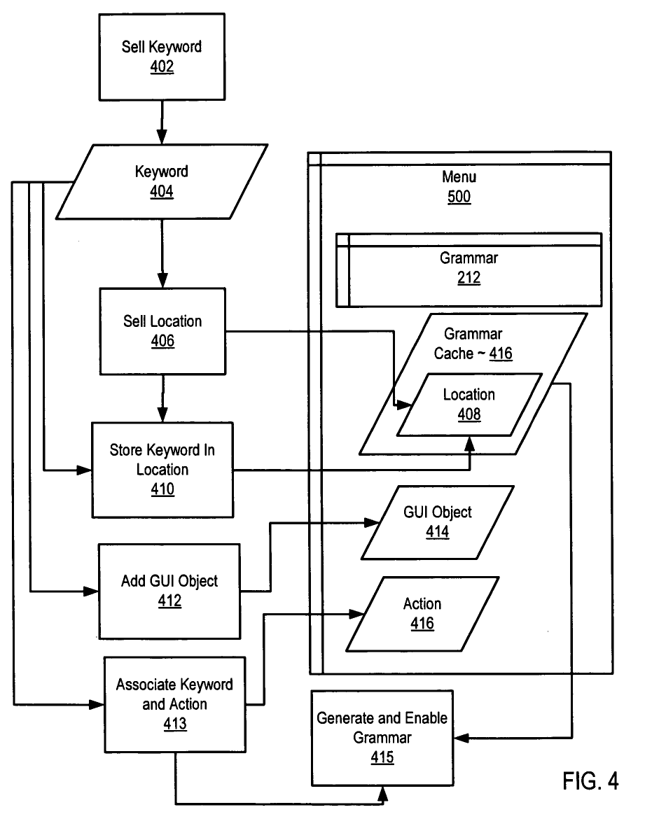

As discussed above, selling customers keywords and locations in a hierarchical multimodal menu provides to those customers the ability to increase their presence with users of the menu. For further explanation therefore, FIG. 4 sets forth a flow chart illustrating an exemplary method for modifying a grammar of a hierarchical multimodal menu. The method of FIG. 4 includes selling (402) to a customer a keyword (404). A keyword may be a descriptive keyword useful in identifying a product or area of business of the customer, a customer trademark or service mark, or any other keyword that will occur to those of skill in the art. Keywords that are more descriptive and more broadly used my command higher sale prices than keywords that more specifically identify a particular customer. Some keywords for sale may be speech commands that already exist in the grammar while other keywords may be words that are parsed against a grammar to identify speech commands that invoke a particular action. Some keywords may not be available for sale because their sale may limit a user's ability to navigate the menu. The sale price and keywords available for sale therefore will vary as will occur to those of skill in the art.

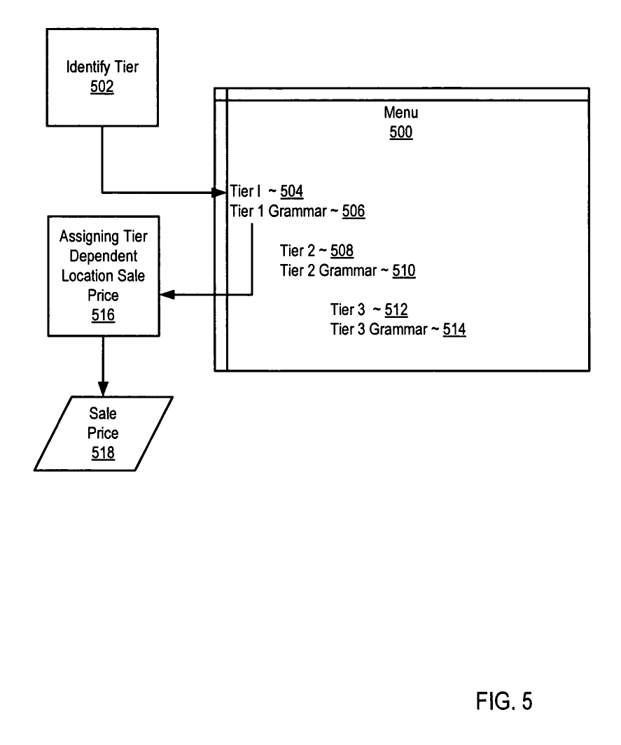

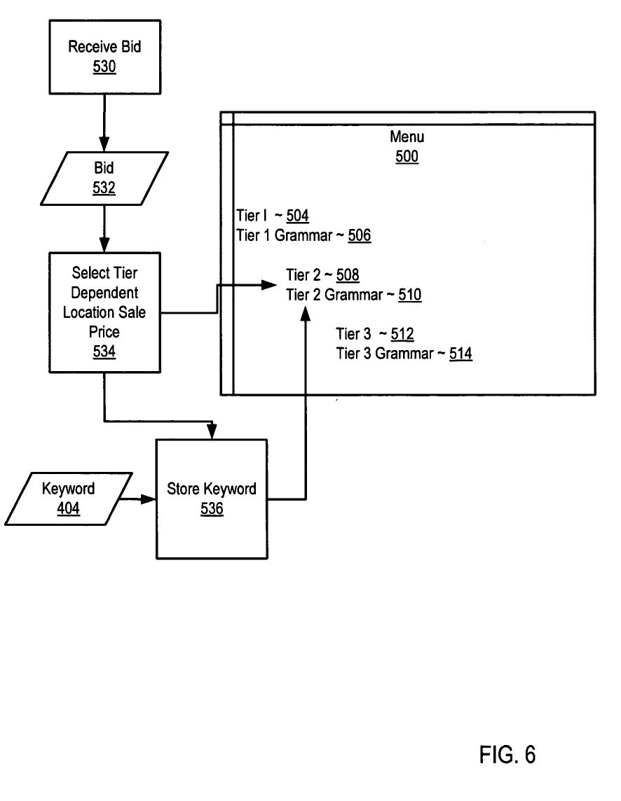

The method of FIG. 4 also includes selling (406) to a customer a location (408) in a grammar (212) in a hierarchical multimodal menu. As discussed in more detail below with reference to FIGS. 5 and 6, selling a location in a grammar in a hierarchical multimodal menu may be carried out by identifying a tier in the hierarchical multimodal menu and assigning a sale price to a location in a grammar associated with that identified tier. Keywords in higher tiers of the menu are often assigned higher sale prices than keywords in lower tiers as typically more users are presented with the higher tier menus more often than the lower tier menus.

Selling a location in a grammar in a hierarchical multimodal menu may also be carried out by receiving bid prices from customers, selecting a tier in the hierarchical multimodal menu in dependence upon the bid price, and storing the keyword in a location in a grammar associated with the selected tier. In such embodiments, customers may bid for placement in the hierarchical menu.

The method of FIG. 4 also includes storing (410) the keyword (404) in the location (408). Storing (410) the keyword (404) in the location (408) is typically carried out by storing the keyword (404) in a grammar (416) cache in the grammar (212). A grammar cache (416) is memory available to a speech recognition engine that makes up a part of a grammar associated with a particular tier of the hierarchical multimodal menu and available for storing keywords sold to customers. Storing a keyword in a location in a grammar cache may be carried out by storing the keyword in the grammar cache first-in-first-out (‘FIFO’), last-in-first-out (‘LIFO’) or in other ways as will occur to those of skill in the art. Providing a grammar cache advantageously allows for the creation of hierarchical multimodal menus that are flexible and capable of modification according to methods of the present invention.

The locations in the grammar cache do not reflect ordered or prioritized keywords. A keyword in the grammar cache makes the keyword available for use in the grammar associated with that tier in the hierarchical menu. That is, it is the tier of the grammar that provides the increases exposure to the user and therefore commands a particular sale price.

The method of FIG. 4 also includes adding (412) a GUI display object (414) associated with the keyword (404) to the hierarchical multimodal menu (500). Adding a GUI display object associated with the keyword notifies the user of the keyword's new presence in the grammar. The GUI display object may simply be the text of the keyword. Alternatively, the GUI display object may be an icon associated with the customer, or any other GUI display object that will occur to those of skill in the art.

The method of FIG. 4 also includes associating (413) the keyword with an action (416). Invoking a keyword typically results in an action. An action is typically a function or set of functions whose execution is invoked by one or more keywords. Consider for example the action goToIBM.com( ). GoToIBM.com retrieves and displays to a user an IBM webpage when the user speaks the keyword ‘Big Blue.’ Such an action may be further parameterized to infer a particular page based upon the context of the keyword.

The method of FIG. 4 also includes generating and enabling grammar (415) using the keywords in the grammar cache. Generating and enabling the grammar (415) advantageously makes the keywords stored in the grammar cache effectively a part of the grammar thereby empowering a user to navigate the menu using the keyword stored in the grammar cache.

The method of FIG. 4 may also be implemented as a service for increasing vendor exposure through keyword placement in a multimodal application. That is, a service provider may implement the method of FIG. 4 to sell keyword placement in a multimodal application to specific vendors. Such a service may be carried out by selling to a vendor a keyword, selling to the vendor a location in a grammar in a hierarchical multimodal menu of the multimodal application, and storing the keyword in the location. Selling to a vendor a location in a grammar in a hierarchical multimodal menu may be carried out by identifying a tier in the hierarchical multimodal menu and assigning a sale price to a location in a grammar associated with the tier in the hierarchical multimodal menu of the multimodal application.

Selling to a vendor a location in a grammar in a hierarchical multimodal menu may also be carried out by receiving a bid price from the vendor, selecting a tier in the hierarchical multimodal menu in dependence upon the bid price. Storing the keyword in the location may be carried out by storing the keyword in a location in a grammar associated with the selected tier.

A service provider may also add a GUI display object associated with the keyword to the hierarchical multimodal menu. Adding a GUI display object associated with the keyword to the hierarchical multimodal menu visually increases the vendor's exposure to potential consumers.

For further explanation, FIG. 5 sets forth a flow chart illustrating an exemplary method for selling to a customer a location in a grammar in a hierarchical multimodal menu that includes identifying (502) a tier (504) in the hierarchical multimodal menu (500) and assigning (516) a sale price (518) to a location in a grammar (506) associated with the tier (504) in the hierarchical multimodal menu (500). As discussed above, higher tiers of hierarchical menus typically engage more users. Therefore, the higher tier grammars may command a greater sale price than the lower tier grammars.

In the example of FIG. 5, three tiers in a hierarchical multimodal menu (500) are shown. Tier 1 (504) includes a Tier 1 grammar (506). Tier 2 (508) includes a Tier 2 grammar (510). Tier 3 (512) includes a Tier 3 grammar (514). In the example of FIG. 3, each tier may be assigned a different sale price. Inclusion in the Tier 1 grammar (506) may therefore command a higher sale price than inclusion in the Tier 3 grammar (514).

A grammar cache is typically not visible. The display of the grammar cache in the example of FIG. 5 is therefore for only for explanation, not for limitation. To notify users of additional keywords in the grammar cache, an icon or text is often displayed in the visible menu

In the example of FIG. 5, a sale price for a keywords inclusion in a grammar is dependent upon the tier in the hierarchical multimodal menu associated with the grammar. Sale prices for keywords may also be subject to bidding. For further explanation, FIG. 6 sets forth another exemplary method for selling to a customer a location in a grammar in a hierarchical multimodal menu that includes receiving (530) a bid price (532) from the customer. In some such embodiments, a service provider charged with populating the grammars of a hierarchical multimodal menu may receive from a plurality of customers a plurality of bids for grammar locations in the hierarchical menu.

The method of FIG. 6 also includes selecting (534) a tier (508) in the hierarchical multimodal menu (500) in dependence upon the bid price (532) and storing (536) the keyword (404) in a location in a grammar (510) associated with the selected tier (508). As discussed above, higher tiers of hierarchical menus engage more users. A service provider populating a grammar according to the method of FIG. 6 may therefore select higher tier grammars for higher bidding customers and select the lower tier grammars for lower biding customers.

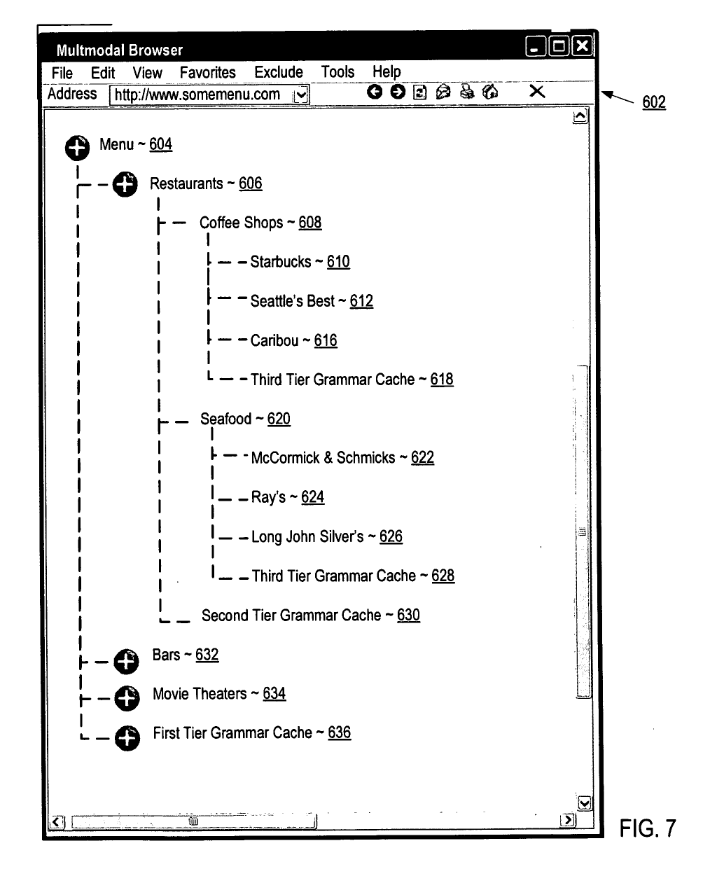

For further explanation, FIG. 7 sets forth a line drawing of an exemplary hierarchical multimodal menu (604) displayed within a multimodal browser (602). The exemplary menu has three first tier entries. The first tier entries include entries for restaurants (606), bars (632), and movie theatres (634). The first tier also includes a first tier grammar cache (636) for storing keywords sold to customers. The inclusion of such keywords in the grammar cache allows a user navigating the menu (604) to invoke the keyword and any associated actions by speaking the keyword while navigating the first tier of the menu. In the example of FIG. 7, the first tier grammar cache is visible. This is for explanation, not for limitation. In fact, grammar caches are typically not visible. To notify users of additional keywords in the grammar cache, an icon or text is often displayed in the visible menu.

The exemplary menu (604) of FIG. 7 also includes a second tier having entries for coffee shops (608) and seafood (620). The second tier also includes a second tier grammar cache (630) for storing keywords sold to customers. The inclusion of such keywords in the grammar cache allows a user navigating the menu to invoke the keyword and any associated actions by speaking the keyword while navigating the second tier of the menu. In the example of FIG. 7, the second tier grammar cache is visible. This is for explanation, not for limitation. In fact, grammar caches are typically not visible. To notify users of additional keywords in the grammar cache, an icon or text is often displayed in the visible menu.

The exemplary menu (604) of FIG. 7 also includes two third tiers. One third tier has entries for the coffee shops (608) and the other third tier has entries for seafood (620). The third tier having entries for the coffee shops (608) includes entries for Starbucks (610), Seattle's Best (612), and Caribou (616). The third tier for the coffee shops also includes a third tier grammar cache (618) for storing keywords sold to customers. The inclusion of such keywords in the grammar cache (618) allows a user navigating the menu to invoke the keyword and any associated actions by speaking the keyword while navigating the third tier for coffee shops of the menu. In the example of FIG. 7, the third tier grammar cache is visible. This is for explanation, not for limitation. In fact, grammar caches are typically not visible. To notify users of additional keywords in the grammar cache, an icon or text is often displayed in the visible menu.

In the example of FIG. 7, the third tier for seafood (620) includes entries for McCormick & Schmicks (622), Ray's (624), and Long John Silver's (626). The third tier for seafood also includes a third tier grammar cache (628) for storing keywords sold to customers. The inclusion of such keywords in the grammar cache (628) allows a user navigating the menu to invoke the keyword and any associated actions by speaking the keyword while navigating the third tier for seafood of the menu. In the example of FIG. 7, the third tier grammar cache is visible. This is for explanation, not for limitation. In fact, grammar caches are typically not visible. To notify users of additional keywords in the grammar cache, an icon or text is often displayed in the visible menu.

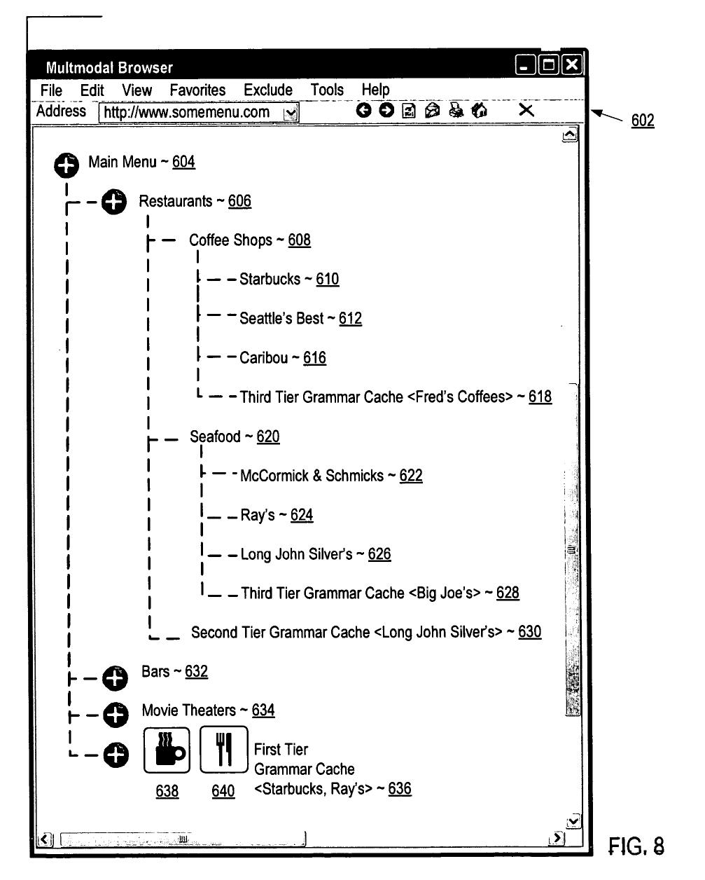

For further explanation, FIG. 8 sets forth the menu of FIG. 7 with a visual representation of exemplary keywords stored in the grammar caches. As discussed above, grammar cache is typically not visible. The display of keywords stored in these grammars is therefore only for explanation, not for limitation. To notify users of additional keywords in the grammar cache, an icon or text is often displayed in the visible menu.

In the example of FIG. 8, the first tier grammar cache (636) includes the keywords Starbucks and Ray's. In the example of FIG. 8, a user navigating the first tier of the menu may invoke the actions associated with Ray's by speaking the keyword ‘Ray's.’ Similarly, a user navigating the first tier of the menu may invoke the actions associated with Starbucks by speaking the keyword ‘Starbucks.’ To notify users of the inclusion of the keyword ‘Starbucks,’ the exemplary menu of FIG. 8 includes a coffee cup ion (638) to represent coffee. To notify users of the inclusion of the keyword ‘Ray's,’ the exemplary menu of FIG. 8 includes a knife and fork icon (638) to represent a restaurant.

In the example of FIG. 8, the second tier grammar cache (630) includes the keyword Long John Silver's. In the example of FIG. 8, a user navigating the second tier of the menu may invoke the actions associated with Long John Silver's by speaking the keyword ‘Long John Silver's.’ In the example of FIG. 8, no text or icon is included in the menu notifying a user of the addition of the keyword in the second tier grammar cache. A user navigating the second tier may invoke the actions associated with Long John Silver's by speaking the keyword ‘Long John Silver's, but the user is not notified with text or an icon of the inclusion of the keyword in the grammar cache.

In the example of FIG. 8, the third tier grammar cache (618) for coffee shops includes the keyword Fred's Coffees. Fred's Coffees was not an entry in the previous menu. A location, however, in the third tier grammar cache was sold to Fred's Coffees and the inclusion of the keyword allows a user navigating the third tier for coffees to invoke an action associated with Fred's Coffees by speaking the keyword ‘Fred's Coffees.’ In the example of FIG. 8, no text or icon is included in the menu notifying a user of the addition of the keyword in the third tier grammar cache. A user navigating the second tier may invoke the actions associated with Fred's Coffees by speaking the keyword Fred's Coffees, but the user is not notified with text or an icon of the inclusion of the keyword in the grammar cache.

In the example of FIG. 8, the third tier grammar cache (628) for seafood shops includes the keyword Big Joe's. As with Fred's Coffees, Big Joe's was not an entry in the previous menu. A location, however, in the third tier grammar cache was sold to Big Joe's and the inclusion of the keyword allows a user navigating the third tier for seafood to invoke an action associated with Big Joe's by speaking the keyword ‘Big Joe's.’ In the example of FIG. 8, no icon or text is included in the menu notifying a user of the addition of the keyword in the second tier grammar cache. A user navigating the second tier may invoke the actions associated with Big Joe's by speaking the keyword ‘Big Joe's,’ but the user is not notified with text or an icon of the inclusion of the keyword in the grammar cache.

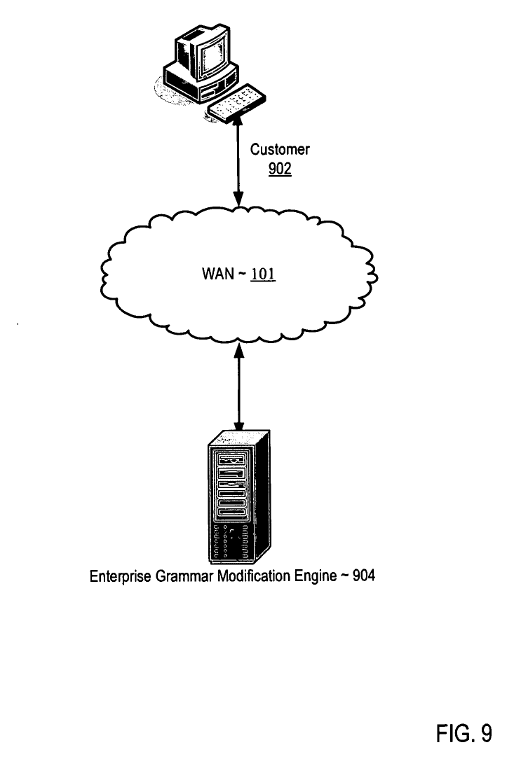

As discussed above, selling customers keywords and locations in a hierarchical multimodal menu provides to those customers the ability to increase their presence with users of a hierarchical multimodal menu. For further explanation therefore, FIG. 9 sets forth a line drawing of an exemplary data processing system useful in modifying a grammar of a hierarchical multimodal menu. The exemplary system includes a customer computer (902) coupled for data communications to an enterprise grammar modification engine (904) through a WAN (101).

The enterprise grammar modification engine (904) of FIG. 9 is capable of selling to a customer a keyword, selling to a customer a location in a grammar in a hierarchical multimodal menu, and storing the keyword in the location. The enterprise grammar modification engine (904) of FIG. 9 is capable of selling to a customer a location in a grammar in a hierarchical multimodal menu by identifying a tier in the hierarchical multimodal menu and assigning a sale price to a location in a grammar associated with that identified tier. The enterprise grammar modification engine (904) of FIG. 9 is also capable of selling to a customer a location in a grammar in a hierarchical multimodal menu by identifying a tier in the hierarchical multimodal menu and assigning a sale price to a location in a grammar associated with that identified tier by receiving bid prices from customers, selecting a tier in the hierarchical multimodal menu in dependence upon the bid price, and storing the keyword in a location in a grammar associated with the selected tier.

The enterprise grammar modification engine (904) of FIG. 9 is also capable of adding a GUI display object associated with the keyword to the hierarchical multimodal menu and associating the keyword with an action. The arrangement of the enterprise grammar modification engine and customer computer making up the exemplary system illustrated in FIG. 9 is for explanation, not for limitation. Data processing systems useful according to various embodiments of the present invention may include additional servers, routers, other devices, and peer-to-peer architectures, not shown in FIG. 9, as will occur to those of skill in the art. It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for modifying a grammar of a hierarchical multimodal menu, the method comprising:
selling to a customer a keyword;
selling to a customer a location in a grammar in a hierarchical multimodal menu; and
storing the keyword in the location.

2. The method of claim 1 wherein selling to a customer a location in a grammar in a hierarchical multimodal menu further comprises:
identifying a tier in the hierarchical multimodal menu; and
assigning a sale price to a location in a grammar associated with the tier in the hierarchical multimodal menu.

3. The method of claim 1 wherein selling to a customer a location in a grammar in a hierarchical multimodal menu further comprises receiving a bid price from the customer; and
selecting a tier in the hierarchical multimodal menu in dependence upon the bid price; and
wherein storing the keyword in the location includes storing the keyword in a location in a grammar associated with the selected tier.

4. The method of claim 1 further comprises adding a GUI display object associated with the keyword to the hierarchical multimodal menu.

5. The method of claim 1 wherein storing the keyword in the location further comprises storing the keyword in a grammar cache in the grammar.

6. The method of claim 1 further comprises associating the keyword with an action.

7. A grammar of a hierarchical multimodal menu, the grammar comprising:
a keyword sold to a customer;
a keyword location sold to a customer; and
a keyword stored in the keyword location.

8. The grammar of claim 7 wherein the keyword location further comprises a keyword location in a grammar associated with a tier in the hierarchical multimodal menu.

9. The grammar of claim 7 wherein the keyword was sold for a bid price from a customer.

10. The grammar of claim 7 further comprises a GUI display object associated with the keyword.

11. The grammar of claim 7 further comprises a grammar cache for storing keywords sold to customers.

12. The grammar of claim 7 further comprises an action associated with the keyword.

13. A service for increasing vendor exposure through keyword placement in a multimodal application, the service comprising:
selling to a vendor a keyword;
selling to the vendor a location in a grammar in a hierarchical multimodal menu of the multimodal application; and
storing the keyword in the location.

14. The service of claim 13 wherein selling to a vendor a location in a grammar in a hierarchical multimodal menu further comprises:
identifying a tier in the hierarchical multimodal menu; and
assigning a sale price to a location in a grammar associated with the tier in the hierarchical multimodal menu of the multimodal application.

15. The service of claim 13 wherein selling to a vendor a location in a grammar in a hierarchical multimodal menu further comprises receiving a bid price from the vendor; and
selecting a tier in the hierarchical multimodal menu in dependence upon the bid price; and
wherein storing the keyword in the location includes storing the keyword in a location in a grammar associated with the selected tier.

16. The service of claim 1 further comprises adding a GUI display object associated with the keyword to the hierarchical multimodal menu.

17. A computer program product for modifying a grammar of a hierarchical multimodal menu, the computer program product disposed upon a recording medium, the computer program product comprising:
computer program instructions that sell to a customer a keyword;
computer program instructions that sell to a customer a location in a grammar in a hierarchical multimodal menu; and
computer program instructions that store the keyword in the location.

18. The computer program product of claim 17 wherein computer program instructions that sell to a customer a location in a grammar in a hierarchical multimodal menu further comprise:
computer program instructions that identify a tier in the hierarchical multimodal menu; and
computer program instructions that assign a sale price to a location in a grammar associated with the tier in the hierarchical multimodal menu.

19. The computer program product of claim 17 wherein computer program instructions that sell to a customer a location in a grammar in a hierarchical multimodal menu further comprise computer program instructions that receive a bid price from the customer;
computer program instructions that select a tier in the hierarchical multimodal menu in dependence upon the bid price; and
computer program instructions that store the keyword in the location includes means, recorded on the recording medium, for storing the keyword in a location in a grammar associated with the selected tier.

20. The computer program product of claim 17 further comprising computer program instructions that associate the keyword with an action.
